(19) United States
(12) Patent Application Publication
(10) Pub. No.: US 2024/0397421 A1
(43) Pub. Date: Nov. 28, 2024

(54) METHOD AND APPARATUS FOR DETERMINING CELL CONFIGURATION

(71) Applicant: Beijing Xiaomi Mobile Software Co., ltd., Beijing (CN)

(72) Inventor: Yang LIU, Beijing (CN)

(21) Appl. No.: 18/694,210

(22) PCT Filed: Sep. 24, 2021
(86) PCT No.: PCT/CN2021/120460

§ 371 Date: Mar. 21, 2024

(51) Int. Cl. H04W 52/02; H04W 72/231; H04W 76/20

(52) U.S. Cl. CPC H04W 52/0206; H04W 52/0235; H04W 72/231; H04W 76/20

(57) ABSTRACT

A method for determining cell configuration is performed by a base station, and includes: determining energy saving mode configuration for a cell located within a coverage of the base station, wherein an energy consumption of the base station caused by the cell using the energy saving mode configuration is lower than an energy consumption of the base station caused by the cell not using the energy saving mode configuration.

### CROSS-REFERENCE TO RELATED APPLICATION

The present application is the U.S. national stage of International Application No. PCT/CN2021/120460, filed on Sep. 24, 2021, the disclosure of which is incorporated herein by reference in its entirety.

### TECHNICAL FIELD

The present disclosure relates to the field of mobile communication technologies, and in particular to a method and apparatus for determining cell configuration.

### BACKGROUND

With massive popularity of commercial use of 5G networks, high power consumptions of 5G networks have become a thorny issue for operators in a process of large-scale deployment of the 5G networks. The operators are eagerly looking forward to a technical solution that can reduce the power consumptions of mobile communication networks, especially technical means that can reduce energy consumptions of 5G base stations.

### SUMMARY

The present disclosure proposes a method and apparatus for determining cell configuration.

An embodiment in a first aspect of the present disclosure provides a method for determining cell configuration. The method is performed by a base station, and includes determining energy saving mode configuration for a cell located within a coverage of the base station. Herein, an energy consumption of the base station caused by the cell using the energy saving mode configuration is lower than an energy consumption of the base station caused by the cell not using the energy saving mode configuration.

An embodiment in a second aspect of the present disclosure provides a method for determining cell configuration. The method is performed by a UE, and includes receiving energy saving mode information sent by a base station. Herein, the energy saving mode information is used for indicating energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration. The method further includes determining, based on the energy saving mode information, the energy saving mode configuration of the current serving cell and the neighbor cell of the current serving cell.

An embodiment in a third aspect of the present disclosure provides a communication device. The communication device includes a transceiver, a memory, and a processor that is connected to the transceiver and the memory respectively and is configured to, through executing a computer-executable instruction of the memory, control sending and receiving of a wireless signal of the transceiver and be capable of implementing the method for determining the cell configuration according to embodiments in the first aspect or embodiments in the second aspect.

An embodiment in a fourth aspect of the present disclosure provides a computer storage medium. The computer storage medium stores a computer-executable instruction. The computer-executable instruction, when executed by a processor, is capable of implementing the method for determining the cell configuration according to embodiments in the first aspect or embodiments in the second aspect.

### BRIEF DESCRIPTION OF THE DRAWINGS

The foregoing and/or additional aspects and advantages of the present disclosure will become apparent and readily understood from the following description of the embodiments in conjunction with the accompanying drawings.

FIG. 1 is a schematic diagram of an architecture of a communication system according to an embodiment of the present disclosure.

FIG. 2 is a schematic flowchart of a method for determining cell configuration according to an embodiment of the present disclosure.

FIG. 3 is a schematic flowchart of a method for determining cell configuration according to an embodiment of the present disclosure.

FIG. 4 is a schematic flowchart of a method for determining cell configuration according to an embodiment of the present disclosure.

FIG. 5 is a schematic flowchart of a method for determining cell configuration according to an embodiment of the present disclosure.

FIG. 6 is a schematic flowchart of a method for determining cell configuration according to an embodiment of the present disclosure.

FIG. 7 is a schematic flowchart of a method for determining cell configuration according to an embodiment of the present disclosure.

FIG. 8 is a schematic diagram of a structure of an apparatus for determining cell configuration provided in an embodiment of the present disclosure.

FIG. 9 is a schematic diagram of a structure of an apparatus for determining cell configuration provided in an embodiment of the present disclosure.

FIG. 10 is a schematic diagram of a structure of an apparatus for determining cell configuration provided in an embodiment of the present disclosure.

FIG. 11 is a schematic diagram of a structure of an apparatus for determining cell configuration provided in an embodiment of the present disclosure.

FIG. 12 is a schematic diagram of a structure of an apparatus for determining cell configuration provided in an embodiment of the present disclosure.

FIG. 13 is a schematic diagram of a structure of a communication device provided in an embodiment of the present disclosure.

FIG. 14 is a schematic diagram of a structure of a chip provided in an embodiment of the present disclosure.

### DETAILED DESCRIPTION

The embodiments of the present disclosure are described in detail below, and examples of the embodiments are illustrated in the accompanying drawings, where the same or similar labels throughout indicate the same or similar elements or elements having the same or similar functions. The embodiments described below by reference to the accompanying drawings are exemplary and are intended to be used for explaining the present disclosure and are not to be construed as a limitation of the present disclosure.

A communication system to which the embodiments of the present disclosure are applicable is first described below in order to better understand the method and apparatus for determining the cell configuration disclosed in the embodiments of the present disclosure.

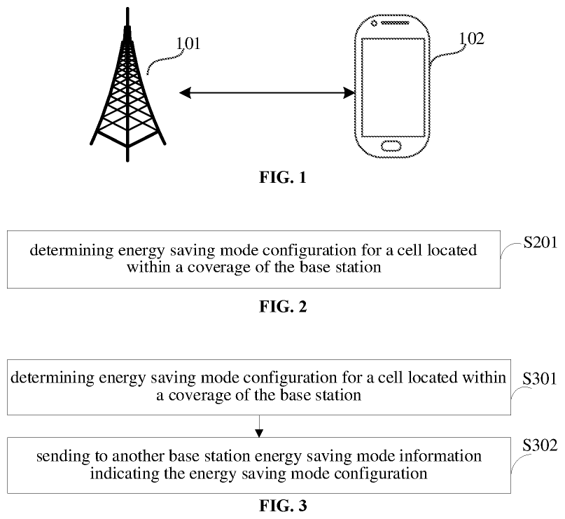

Referring to FIG. 1, FIG. 1 is a schematic diagram of an architecture of a communication system provided in an embodiment of the present disclosure. The communication system may include, but is not limited to, a network device and a terminal device. The numbers and forms of the devices shown in FIG. 1 are for example only and do not constitute a limitation of the embodiments of the present disclosure, and two or more network devices and two or more terminal devices may be included in actual applications. The communication system shown in FIG. 1 includes a network device 101 and a terminal device 102 as an example.

It should be illustrated that technical solutions of the embodiments of the present disclosure may be applied to various communication systems, for example, long-term evolution (LTE) systems, 5th generation (5G) mobile communication systems, 5G new radio (NR) systems, or other future new mobile communication systems.

The network device 101 in an embodiment of the present disclosure is an entity at the network side for sending or receiving signals. For example, the network device 101 may be an evolved NodeB (eNB), a transmission reception point (TRP), a next generation NodeB (gNB) in NR systems, a base station in other future mobile communication systems, or an access node in wireless fidelity (WiFi) systems. The embodiments of the present disclosure do not limit the specific technology and device form used by the network device. The network device provided by an embodiment of the present disclosure may be composed of a central unit (CU) and a distributed unit (DU), where the CU may also be referred to as a control unit. The CU-DU structure may be used to separate the protocol layer of the network device such as a base station, with a part of functions of the protocol layer placed under centralized control in the CU, and the remaining functions or all functions of the protocol layer distributed in the DU, and the DU being centrally controlled by the CU.

The terminal device 102 in an embodiment of the present disclosure is an entity at the user side for receiving or sending signals, such as a mobile phone. The terminal device may also be referred to as a user equipment (UE), a mobile station (MS), a mobile terminal (MT), etc. The terminal device may be a device with communication capabilities such as a car, a smart car, a mobile phone, a wearable device, or a pad: or the terminal device may be a computer with wireless transceiver capabilities, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiments of the present disclosure do not limit the specific technology and device form used by the terminal device.

It can be understood that the communication system described in the embodiments of the present disclosure is intended to provide a clearer explanation of the technical solutions of the embodiments of the present disclosure, and does not constitute a limitation to the technical solutions provided by the embodiments of the present disclosure. As those ordinary skilled in the art may know, with evolution of the system architecture and emergence of new service scenarios, the technical solutions provided by the embodiments of the present disclosure are also applicable to similar technical problems.

With massive popularity of commercial use of 5G networks, high power consumptions of 5G networks have become a thorny issue for operators in a process of large-scale deployment of the 5G networks. The operators are eagerly looking forward to a technical solution that can reduce the power consumptions of mobile communication networks, especially technical means that can reduce energy consumptions of 5G base stations.

In the prior art, two ways are generally used in order to save an energy consumption of a base station. One is to update hardware design of the base station to achieve the purpose of saving the energy consumption, and the other is to turn off a part of modules in the base station and make the base station to be dormant to achieve the purpose of saving the energy consumption.

Base station dormancy generally occurs when there is no UE in cells within a coverage of the base station in a connected state, or occurs during non-scheduled time periods. However, setting the base station to be dormant may prolong a period of a synchronization signal and a PBCH block (SSB) and have a large impact on the UE in an idle state, causing that it is necessary for the base station to judge conditions of the UE in the idle state in order to set the base station to be dormant, which aggravates an operation burden of the base station.

The present disclosure proposes a method and apparatus for determining cell configuration, which can provide energy saving mode configuration for a cell, thereby achieving the purpose of reducing the energy consumption of the base station.

The method and apparatus for determining the cell configuration provided in the present disclosure are described in detail below in conjunction with the accompanying drawings.

FIG. 2 illustrates a schematic flowchart of a method for determining cell configuration according to an embodiment of the present disclosure. As shown in FIG. 2, the method may be performed by a base station and includes the following step S201.

At step S201, energy saving mode configuration is determining for a cell located within a coverage of the base station. Herein, an energy consumption of the base station caused by the cell using the energy saving mode configuration is lower than an energy consumption of the base station caused by the cell not using the energy saving mode configuration.

In this embodiment, the energy saving mode configuration may be provided for the cell. Compared to the non-energy saving mode configuration, the energy consumption of the base station caused by the cell in the energy saving mode configuration is lower, but the cell still has a capability to provide services compared to conditions in which the cell/base station is dormant, which avoids the large impact on the UE in the idle state within the cell. Therefore, compared to the prior art in which the base station/cell is dormant, the embodiment of the present disclosure avoids, through providing the energy saving mode configuration for the cell, an additional judgement of the base station on the conditions of the UE in the idle state, and does not impose an additional operation burden on the base station.

In some embodiments, the energy saving mode configuration includes configuring any one of: a sending period of an SSB, a number of an available beam, or a silence pattern.

For example, the number of available beams in the energy saving mode configuration may be set to be less than the number of available beams in the non-energy saving mode, thereby avoiding an energy consumption caused by too many beams.

For another example, the sending period of the SSB in the energy saving mode configuration is slightly longer than the sending period of the SSB in the non-energy saving mode, while avoiding that this extended sending period of the SSB has a large impact on the UE in the idle state within the cell. As a result, the sending of the SSB may be reduced without having the impact on the UE in the idle state, thereby achieving the purpose of reducing the energy consumption.

For another example, the silence pattern in the energy saving mode configuration may be set, and the silence pattern indicates positions on a resource unit that are to be silenced, i.e., no data is to be transmitted at those positions. The purpose of reducing the energy consumption can be achieved by appropriately setting the silence pattern.

According to the method for determining the cell configuration of the embodiment of the present disclosure, the base station determines the energy saving mode configuration for the cell located within the coverage of the base station, and the energy consumption of the base station caused by the cell using the energy saving mode configuration is lower than the energy consumption of the base station caused by the cell not using the energy saving mode configuration. As a result, the energy saving mode configuration is provided for the cell, and the purpose of reducing the energy consumption of the base station can be achieved by using the energy saving mode configuration. Meanwhile, compared to the prior art in which the base station/cell is dormant, the method of the embodiment of the present disclosure does not impose the additional operation burden on the base station.

FIG. 3 illustrates a schematic flowchart of a method for determining cell configuration according to an embodiment of the present disclosure. As shown in FIG. 3, the method may be performed by a base station and includes the following steps S301 to S302.

At step S301, energy saving mode configuration is determining for a cell located within a coverage of the base station. Herein, an energy consumption of the base station caused by the cell using the energy saving mode configuration is lower than an energy consumption of the base station caused by the cell not using the energy saving mode configuration.

In some embodiments, the energy saving mode configuration includes configuring any one of: a sending period of an SSB, a number of an available beam, or a silence pattern.

For a detailed description of the above step S301, reference may be made to the description of step S201 and its related details, which will not be repeated herein.

At step S302, energy saving mode information indicating the energy saving mode configuration is sent to another base station.

In this embodiment, the base station may send to another base station the energy saving mode information indicative of the energy saving mode configuration, for example, via an interface between base stations, such as an X2 interface. The another base station may be capable of obtaining the energy saving mode configuration of relevant cells based on the energy saving mode information, which therefore may be more conducive for the another base station to perform corresponding operations based on the energy saving mode configuration of these cells, such as performing inter-base station handovers and the like.

According to the method for determining the cell configuration of the embodiment of the present disclosure, the base station may send to another base station the energy saving mode information indicative of the energy saving mode configuration of the relevant cells, and the another base station may be capable of determining the energy saving mode configuration of these cells based on the energy saving mode information, which therefore may be more conducive for the another base station to perform corresponding operations based on the energy saving mode configuration of these cells.

FIG. 4 illustrates a schematic flowchart of a method for determining cell configuration according to an embodiment of the present disclosure. As shown in FIG. 4, the method may be performed by a base station and includes the following steps S401 to S402.

At step S401, energy saving mode configuration is determining for a cell located within a coverage of the base station. Herein, an energy consumption of the base station caused by the cell using the energy saving mode configuration is lower than an energy consumption of the base station caused by the cell not using the energy saving mode configuration.

In some embodiments, the energy saving mode configuration includes configuring any one of: a sending period of an SSB, a number of an available beam, or a silence pattern.

For a detailed description of the above step S401, reference may be made to the description of step S201 and its related details, which will not be repeated herein.

At step S402, energy saving mode information indicating the energy saving mode configuration is sent to a UE served by the cell or by a neighbor cell of the cell.

In some embodiments, sending, to the UE served by the cell or by the neighbor cell of the cell, the energy saving mode information indicating the energy saving mode configuration includes sending the energy saving mode information to the UE through a system broadcast or an RRC signaling.

In this embodiment, by sending, to the UE served by the cell or by the neighbor cell of the cell, the energy saving mode information indicative of the energy saving mode configuration of the cells, for example through a system broadcast message or through the RRC signaling, the UE is capable of obtaining, based on the energy saving mode information, the energy saving mode configuration of the serving cell of the UE and the neighbor cell of the serving cell, and thus the UE is capable of obtaining the capabilities of the serving cell and the neighbor cell of the serving cell to provide services for the UE, which is more conducive for the UE to perform corresponding operations based on the energy saving mode configuration of the cells, such as determining a new serving cell and the like.

According to the method for determining the cell configuration of the embodiment of the present disclosure, the base station may send, to the UE served by the cell or by the neighbor cell of the cell, the energy saving mode information indicative of the energy saving mode configuration of the cells, and the UE is capable of determining, based on the energy saving mode information, the energy saving mode configuration of the cells. As a result, the UE is capable of obtaining, based on the energy saving mode configuration of the serving cell and the neighbor cell of the serving cell, the capabilities of the serving cell and the neighbor cell of the serving cell to provide services for the UE.

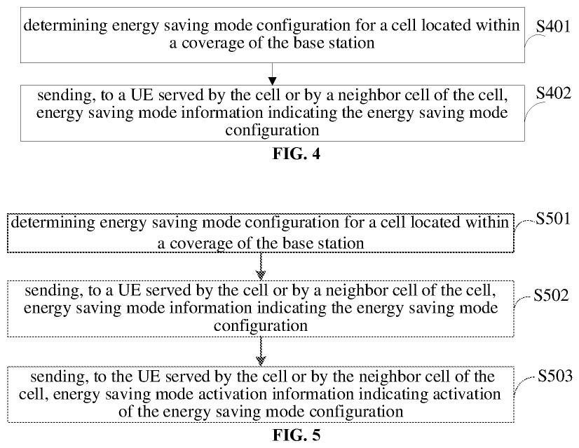

FIG. 5 illustrates a schematic flowchart of a method for determining cell configuration according to an embodiment of the present disclosure. As shown in FIG. 5, the method may be performed by a base station and includes the following steps S501 to S503.

At step S501, energy saving mode configuration is determining for a cell located within a coverage of the base station. Herein, an energy consumption of the base station caused by the cell using the energy saving mode configuration is lower than an energy consumption of the base station caused by the cell not using the energy saving mode configuration.

In some embodiments, the energy saving mode configuration includes configuring any one of: a sending period of an SSB, a number of an available beam, or a silence pattern.

For a detailed description of the above step S501, reference may be made to the description of step S201 and its related details, which will not be repeated herein.

At step S502, energy saving mode information indicating the energy saving mode configuration is sent to a UE served by the cell or by a neighbor cell of the cell.

In some embodiments, sending, to the UE served by the cell or by the neighbor cell of the cell, the energy saving mode information indicating the energy saving mode configuration includes sending the energy saving mode information to the UE through a system broadcast or an RRC signaling.

For a detailed description of the above step S502, reference may be made to the description of step S402 and its related details, which will not be repeated herein.

Optionally, the energy saving mode configuration may be activated automatically after the base station determines the energy saving mode configuration for the cell, i.e., the cell automatically enters the energy saving mode configuration after the base station determines the energy saving mode configuration for the cell.

Optionally, the energy saving mode configuration is not activated instantly after the base station determines the energy saving mode configuration for the cell, but may be activated when needed, for example, when the base station is overloaded, etc., in which case the base station needs to notify the UE that the energy saving mode configuration of the relevant cell is activated, as described in step S503 below.

At step S503, energy saving mode activation information indicating activation of the energy saving mode configuration is sent to the UE served by the cell or by the neighbor cell of the cell.

In some embodiments, sending, to the UE served by the cell or by the neighbor cell of the cell, the energy saving mode activation information indicating the activation of the energy saving mode configuration includes sending the energy saving mode activation information to the UE through downlink control information.

In this embodiment, the base station, after determining that the energy saving mode configuration is enabled in a certain cell, sends to the UE served by the cell or by the neighbor cell of the cell the energy saving mode activation information indicative of the activation of the energy saving mode configuration of the cell, for example, by carrying the energy saving mode activation information in the DCI, so that the UE is informed that the energy saving mode configuration is enabled in the cell, and the UE is thus capable of performing relevant operations according to the energy saving mode configuration of the cell.

According to the method for determining the cell configuration of the embodiment of the present disclosure, the base station may send to the UE served by the cell or by the neighbor cell of the cell the energy saving mode activation information indicative of the activation of the energy saving mode configuration of the cell, and the UE may be capable of determining, based on the energy saving mode activation information, which cells have enabled the energy saving mode configuration, and thus the UE may be capable of performing relevant operations based on the enabled energy saving mode configuration.

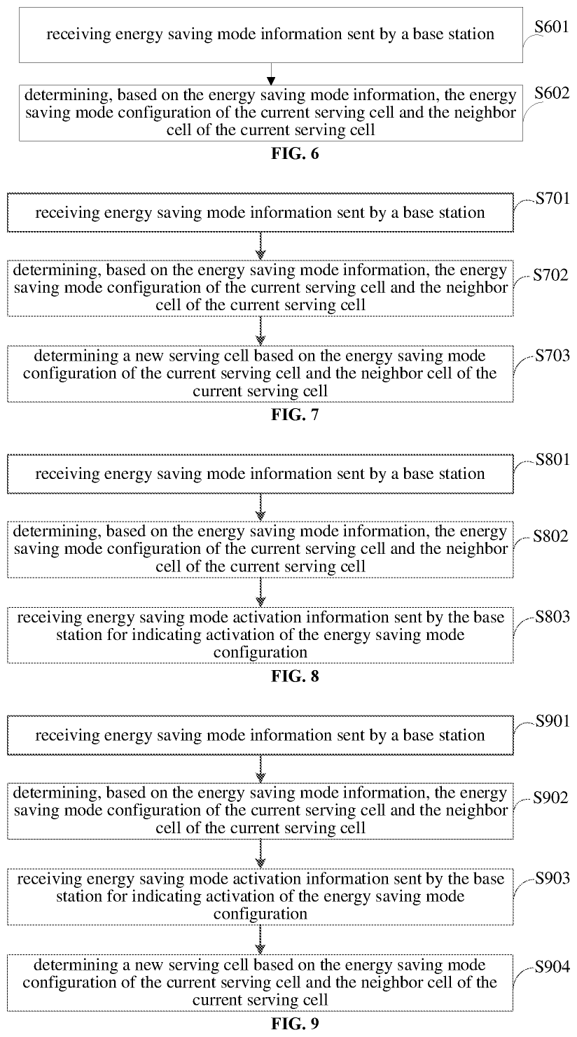

FIG. 6 illustrates a schematic flowchart of a method for determining cell configuration according to an embodiment of the present disclosure. As shown in FIG. 6, the method may be performed by a UE and includes the following steps S601 to S602.

At step S601, energy saving mode information sent by a base station is received. Herein, the energy saving mode information is used for indicating energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration.

In this embodiment, the base station may determine the energy saving mode configuration for the cell, and the UE may receive from the base station the energy saving mode information indicative of the energy saving mode configuration of the current serving cell and the neighbor cell of the current serving cell. Compared to the non-energy saving mode configuration, the energy consumption of the base station caused by the cell in the energy saving mode configuration is lower, but the cell still has a capability to provide services compared to conditions in which the cell/base station is dormant, which avoids the large impact on the UE in the idle state within the cell. Therefore, compared to the prior art in which the base station/cell is dormant, the embodiment of the present disclosure avoids, through providing the energy saving mode configuration for the cell, an additional judgement of the base station on the conditions of the UE in the idle state, and does not impose an additional operation burden on the base station.

In some embodiments, the energy saving mode configuration includes configuring any one of: a sending period of an SSB, a number of an available beam, or a silence pattern.

For example, the number of available beams in the energy saving mode configuration may be set to be less than the number of available beams in the non-energy saving mode, thereby avoiding an energy consumption caused by too many beams.

For another example, the sending period of the SSB in the energy saving mode configuration is slightly longer than the sending period of the SSB in the non-energy saving mode, while avoiding that this extended sending period of the SSB has a large impact on the UE in the idle state within the cell. As a result, the sending of the SSB may be reduced without having the impact on the UE in the idle state, thereby achieving the purpose of reducing the energy consumption.

For another example, the silence pattern in the energy saving mode configuration may be set, and the silence pattern indicates positions on a resource unit that are to be silenced, i.e., no data is to be transmitted at those positions. The purpose of reducing the energy consumption can be achieved by appropriately setting the silence pattern.

In some embodiments, receiving the energy saving mode information sent by the base station includes receiving, through a system broadcast or an RRC signaling, the energy saving mode information sent by the base station.

At step S602, the energy saving mode configuration of the current serving cell and the neighbor cell of the current serving cell is determined based on the energy saving mode information.

In this embodiment, the UE may determine the energy saving mode configuration of the current serving cell and the neighbor cell of the current serving cell based on the energy saving mode information as received.

According to the method for determining the cell configuration of the embodiment of the present disclosure, the base station sends to the UE the energy saving mode information indicative of the energy saving mode configuration of the serving cell of the UE and the neighbor cell of the serving cell, and the UE determines the energy saving mode configuration of the serving cell and the neighbor cell of the serving cell based on the energy saving mode information. As a result, the UE is capable of obtaining, based on the energy saving mode configuration of the serving cell and the neighbor cell of the serving cell, capabilities of the serving cell and the neighbor cell of the serving cell to provide services for the UE.

FIG. 7 illustrates a schematic flowchart of a method for determining cell configuration according to an embodiment of the present disclosure. As shown in FIG. 7, the method may be performed by a UE and includes the following steps S701 to S703.

At step S701, energy saving mode information sent by a base station is received. Herein, the energy saving mode information is used for indicating energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration.

In some embodiments, the energy saving mode configuration includes configuring any one of: a sending period of an SSB, a number of an available beam, or a silence pattern.

In some embodiments, receiving the energy saving mode information sent by the base station includes receiving, through a system broadcast or an RRC signaling, the energy saving mode information sent by the base station.

For a detailed description of the above step S701, reference may be made to the description of step S601 and its related details, which will not be repeated herein.

At step S702, the energy saving mode configuration of the current serving cell and the neighbor cell of the current serving cell is determined based on the energy saving mode information.

For a detailed description of the above step S702, reference may be made to the description of step S602 and its related details, which will not be repeated herein.

At step S703, a new serving cell is determined based on the energy saving mode configuration of the current serving cell and the neighbor cell of the current serving cell.

In this embodiment, after the UE obtains the energy saving mode configuration of the current serving cell and the neighbor cell of the current serving cell, the UE may determine, during a cell selection/reselection process, the new serving cell based on an existing reselection strategy and consideration of the energy saving mode configuration of these cells. For example, the UE may consider the impact on its service or on the synchronization performance when a certain cell is in the energy saving mode configuration, if the impact is acceptable, the UE may consider using the cell as the new serving cell, and if the impact is not acceptable, the UE may not reselect to the cell.

According to the method for determining the cell configuration of the embodiment of the present disclosure, the base station sends to the UE the energy saving mode information indicative of the energy saving mode configuration of the serving cell of the UE and the neighbor cell of the serving cell, the UE determines the energy saving mode configuration of the serving cell and the neighbor cell of the serving cell based on the energy saving mode information, and the UE determines the new serving cell based on the energy saving mode configuration of the serving cell and the neighbor cell of the serving cell. As a result, the UE is capable of selecting a suitable cell even though there are cells in the energy saving mode configuration.

FIG. 8 illustrates a schematic flowchart of a method for determining cell configuration according to an embodiment of the present disclosure. As shown in FIG. 8, the method may be performed by a UE and includes the following steps S801 to S803.

At step S801, energy saving mode information sent by a base station is received. Herein, the energy saving mode information is used for indicating energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration.

In some embodiments, the energy saving mode configuration includes configuring any one of: a sending period of an SSB, a number of an available beam, or a silence pattern.

In some embodiments, receiving the energy saving mode information sent by the base station includes receiving, through a system broadcast or an RRC signaling, the energy saving mode information sent by the base station.

For a detailed description of the above step S801, reference may be made to the description of step S601 and its related details, which will not be repeated herein.

At step S802, the energy saving mode configuration of the current serving cell and the neighbor cell of the current serving cell is determined based on the energy saving mode information.

For a detailed description of the above step S802, reference may be made to the description of step S602 and its related details, which will not be repeated herein.

In some embodiments, the energy saving mode configuration may be activated automatically after the base station determines the energy saving mode configuration for the cell, i.e., the cell automatically enters the energy saving mode configuration after the base station determines the energy saving mode configuration for the cell. The UE may consider, after receiving the energy saving mode information, that the corresponding cell has enabled the energy saving mode configuration.

In other embodiments, the energy saving mode configuration is not activated instantly after the base station determines the energy saving mode configuration for the cell, but may be activated when needed, for example, when the base station is overloaded, etc., and in this case the base station needs to notify the UE that the energy saving mode configuration of the relevant cell is activated, as described in step S803 below.

At step S803, energy saving mode activation information sent by the base station for indicating activation of the energy saving mode configuration is received.

In some embodiments, receiving the energy saving mode activation information sent by the base station for indicating the activation of the energy saving mode configuration includes receiving, through downlink control information, the energy saving mode activation information sent by the base station.

In this embodiment, the base station, after determining that the energy saving mode configuration is enabled in a certain cell, sends to the UE served by the cell or by the neighbor cell of the cell the energy saving mode activation information indicative of the activation of the energy saving mode configuration of the cell, for example, by carrying the energy saving mode activation information in the DCI, so that the UE is informed that the energy saving mode configuration is enabled in the cell, and the UE is thus capable of performing relevant operations according to the energy saving mode configuration of the cell.

According to the method for determining the cell configuration of the embodiment of the present disclosure, the UE receives the energy saving mode activation information sent by the base station for indicating the activation of the energy saving mode configuration of the serving cell of the UE or the neighbor cell of the serving cell, and the UE is capable of determining, based on the energy saving mode activation information, which cells have enabled the energy saving mode configuration, and thus the UE is capable of performing relevant operations based on the enabled energy saving mode configuration.

FIG. 9 illustrates a schematic flowchart of a method for determining cell configuration according to an embodiment of the present disclosure. As shown in FIG. 9, the method may be performed by a UE and includes the following steps S901 to S904.

At step S901, energy saving mode information sent by a base station is received. Herein, the energy saving mode information is used for indicating energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration.

In some embodiments, the energy saving mode configuration includes configuring any one of: a sending period of an SSB, a number of an available beam, or a silence pattern.

In some embodiments, receiving the energy saving mode information sent by the base station includes receiving, through a system broadcast or an RRC signaling, the energy saving mode information sent by the base station.

For a detailed description of the above step S901, reference may be made to the description of step S601 and its related details, which will not be repeated herein.

At step S902, the energy saving mode configuration of the current serving cell and the neighbor cell of the current serving cell is determined based on the energy saving mode information.

For a detailed description of the above step S902, reference may be made to the description of step S602 and its related details, which will not be repeated herein.

At step S903, energy saving mode activation information sent by the base station for indicating activation of the energy saving mode configuration is received.

In some embodiments, receiving the energy saving mode activation information sent by the base station for indicating the activation of the energy saving mode configuration includes receiving, through downlink control information, the energy saving mode activation information sent by the base station.

For a detailed description of the above step S903, reference may be made to the description of step S803 and its related details, which will not be repeated herein.

At step S904, a new serving cell is determined based on the energy saving mode configuration of the current serving cell and the neighbor cell of the current serving cell.

For a detailed description of the above step S904, reference may be made to the description of step S703 and its related details, which will not be repeated herein.

According to the method for determining the cell configuration of the embodiment of the present disclosure, the UE receives the energy saving mode activation information sent by the base station for indicating the activation of the energy saving mode configuration of the serving cell of the UE or the neighbor cell of the serving cell, and the UE is capable of determining, based on the energy saving mode activation information, which cells have enabled the energy saving mode configuration, and thus the UE is capable of determining the new serving cell based on the enabled energy saving mode configuration.

In the above-described embodiments provided in the present disclosure, the methods provided in the embodiments of the present disclosure are described from perspectives of the network device and the UE, respectively. In order to achieve the various functions in the methods provided by the embodiments of the present disclosure, the network device and the UE may include hardware structures and software modules, and may achieve the various functions described above in the form of hardware structures, software modules, or hardware structures plus software modules. One of the above various functions may be executed in the form of the hardware structure, the software module, or the hardware structure plus the software module.

Corresponding to the method for determining the cell configuration provided in the above-described embodiments, the present disclosure also provides an apparatus for determining cell configuration. Since the apparatus for determining the cell configuration provided in the embodiment of the present disclosure corresponds to the method for determining the cell configuration provided in the above-described embodiments, the implementation of the method for determining the cell configuration is also applicable to the apparatus for determining the cell configuration provided by this embodiment, which will not be described in detail in this embodiment.

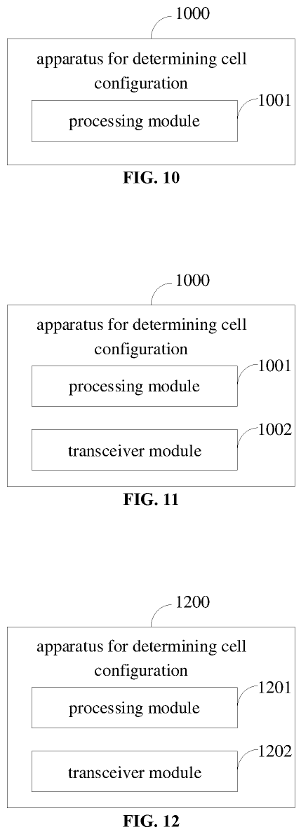

FIG. 10 is a schematic diagram of a structure of an apparatus 1000 for determining cell configuration provided in an embodiment of the present disclosure.

As shown in FIG. 10, the apparatus 1000 may include a processing module 1001, and the processing module 1001 may be configured to determine energy saving mode configuration for a cell located within a coverage of a base station. Herein, an energy consumption of the base station caused by the cell using the energy saving mode configuration is lower than an energy consumption of the base station caused by the cell not using the energy saving mode configuration.

According to the method for determining the cell configuration of the embodiment of the present disclosure, the base station determines the energy saving mode configuration for the cell located within the coverage of the base station, and the energy consumption of the base station caused by the cell using the energy saving mode configuration is lower than the energy consumption of the base station caused by the cell not using the energy saving mode configuration. As a result, the energy saving mode configuration is provided for the cell, and the purpose of reducing the energy consumption of the base station can be achieved by using the energy saving mode configuration. Meanwhile, compared to the prior art in which the base station/cell is dormant, the method of the embodiment of the present disclosure does not impose the additional operation burden on the base station.

In some embodiments, as shown in FIG. 11, the apparatus 1000 may further include a transceiver module 1002, and the transceiver module 1002 may be configured to send to another base station energy saving mode information indicating the energy saving mode configuration.

In some embodiments, the transceiver module 1002 may be configured to send, to a UE served by the cell or by a neighbor cell of the cell, energy saving mode information indicating the energy saving mode configuration.

In some embodiments, the transceiver module 1002 is configured to send the energy saving mode information to the UE through a system broadcast or an RRC signaling.

In some embodiments, the transceiver module 1002 may be configured to send, to the UE served by the cell or by the neighbor cell of the cell, energy saving mode activation information indicating activation of the energy saving mode configuration.

In some embodiments, the transceiver module 1002 is configured to send the energy saving mode activation information to the UE through downlink control information.

In some embodiments, the energy saving mode configuration includes configuring any one of: a sending period of an SSB, a number of an available beam, or a silence pattern.

FIG. 12 is a schematic diagram of a structure of an apparatus 1200 for determining cell configuration provided in an embodiment of the present disclosure.

As shown in FIG. 12, the apparatus 1200 may include a transceiver module 1201 and a processing module 1202.

The transceiver module 1201 may be configured to receive energy saving mode information sent by a base station. Herein, the energy saving mode information is used for indicating energy saving mode configuration of a current serving cell of a UE and a neighbor cell of the current serving cell, and an energy consumption of the base station caused by a cell using the energy saving mode configuration is lower than an energy consumption of the base station caused by the cell not using the energy saving mode configuration.

The processing module 1202 may be configured to determine, based on the energy saving mode information, the energy saving mode configuration of the current serving cell and the neighbor cell of the current serving cell.

According to the method for determining the cell configuration of the embodiment of the present disclosure, the base station sends to the UE the energy saving mode information indicative of the energy saving mode configuration of the serving cell of the UE and the neighbor cell of the serving cell, and the UE determines the energy saving mode configuration of the serving cell and the neighbor cell of the serving cell based on the energy saving mode information. As a result, the UE is capable of obtaining, based on the energy saving mode configuration of the serving cell and the neighbor cell of the serving cell, capabilities of the serving cell and the neighbor cell of the serving cell to provide services for the UE.

In some embodiments, the transceiver module 1201 is configured to receive, through a system broadcast or an RRC signaling, the energy saving mode information sent by the base station.

In some embodiments, the processing module 1202 may be further configured to determine a new serving cell based on the energy saving mode configuration of the current serving cell and the neighbor cell of the current serving cell.

In some embodiments, the transceiver module 1201 may be further configured to receive energy saving mode activation information sent by the base station for indicating activation of the energy saving mode configuration.

In some embodiments, the transceiver module 1201 is configured to receive, through downlink control information, the energy saving mode activation information sent by the base station.

In some embodiments, the energy saving mode configuration includes configuring any one of: a sending period of an SSB, a number of an available beam, or a silence pattern.

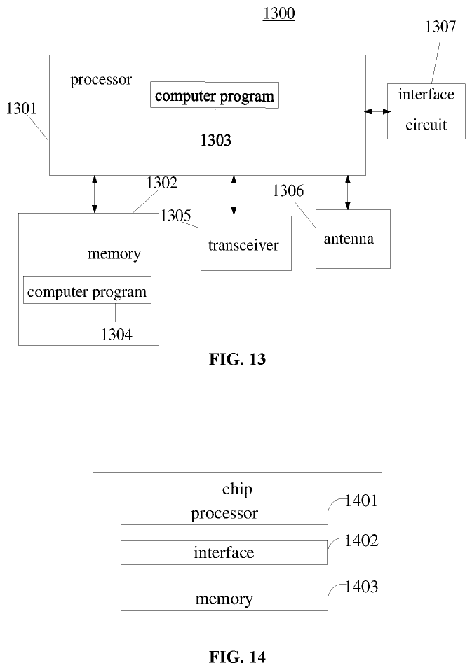

Referring to FIG. 13, FIG. 13 is a schematic diagram of a structure of a communication device 1300 provided in an embodiment of the present disclosure. The communication device 1300 may be a network device, a UE, or a chip, a chip system or a processor, etc. that supports a network device to implement the above-described method, or the communication device 1300 may be a chip, a chip system or a processor, etc. that supports a terminal device to implement the above-described method. The device may be configured to implement the method described in the above method embodiments. For details, please refer to the illustration in the above method embodiments.

The communication device 1300 may include one or more processors 1301. The processor 1301 may be a general purpose processor or a specialized processor, etc. For example, the processor 1301 may be a baseband processor or a central processor. The baseband processor may be configured to process a communication protocol and communication data. The central processor may be configured to control the communication device (e.g., a base station, a baseband chip, a terminal device, a terminal device chip, a DU or a CU, etc.), execute a computer program, and process data of the computer program.

Optionally, the communication device 1300 may further include one or more memories 1302. The one or more memories 1302 may store a computer program 1304. The processor 1301 executes the computer program 1304 to cause the communication device 1300 to perform the method described in the above method embodiments. Optionally, the memory 1302 may also store data. The communication device 1300 and the memory 1302 may be provided separately or may be integrated together.

Optionally, the communication device 1300 may further include a transceiver 1305 and an antenna 1306. The transceiver 1305 may be referred to as a transceiver unit, a transceiver device, or a transceiver circuit, etc., and is configured to implement the receiving and sending functions. The transceiver 1305 may include a receiver and a sender. The receiver may be referred to as a receiving device or a receiving circuit, etc., and is configured to implement a receiving function. The sender may be referred to as a sending device or a sending circuit, etc., and is configured to implement a sending function.

Optionally, the communication device 1300 may further include one or more interface circuits 1307. The interface circuit 1307 is configured to receive a code instruction and transmit the code instruction to the processor 1301. The processor 1301 runs the code instruction to cause the communication device 1300 to perform the method described in the above method embodiments.

The communication device 1300 is a UE: the processor 1301 is configured to perform steps S602 in FIG. 6, S702-S703 in FIG. 7, S802 in FIGS. 8, and S902 and S904 in FIG. 9; and the transceiver 1305 is configured to perform steps S601 in FIG. 6, S701 in FIGS. 7, S801 and S803 in FIGS. 8, and S901 and S903 in FIG. 9.

The communication device 1300 is a network device: the processor 1301 is configured to perform steps S201 in FIG. 2, S301 in FIG. 3, S401 in FIGS. 4, and S501 in FIG. 5; and the transceiver 1305 is configured to perform steps S302 in FIG. 3, S402 in FIGS. 4, and S502-S503 in FIG. 5.

In an implementation, the processor 1301 may include a transceiver configured to implement the receiving and sending functions. For example, the transceiver may be a transceiver circuit, an interface, or an interface circuit. The transceiver circuit, interface, or interface circuit used for implementing the receiving and sending functions may be separate or may be integrated together. The transceiver circuit, interface, or interface circuit described above may be used for code/data reading and writing, or the transceiver circuit, interface, or interface circuit described above may be used for signal transmission or delivery.

In an implementation, the processor 1301 may store a computer program 1303. The computer program 1303 runs on the processor 1301 and may cause the communication device 1300 to perform the method described in the above method embodiments. The computer program 1303 may be solidified in the processor 1301, in which case the processor 1301 may be implemented by hardware.

In an implementation, the communication device 1300 may include a circuit. The circuit may implement the functions of sending, receiving, or communicating in the aforementioned method embodiments. The processor and transceiver described in the present disclosure may be implemented in an integrated circuit (IC), an analog IC, a radio frequency integrated circuit (RFIC), a mixed signal IC, an application specific integrated circuit (ASIC), a printed circuit board (PCB), or an electronic device, etc. The processor and transceiver may also be manufactured by using various IC process technologies, such as the complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), or gallium arsenide (GaAs), etc.

The communication device in the above embodiment description may be a network device or a terminal device (such as the first terminal device in the aforementioned method embodiments), but the scope of the communication device described in the present disclosure is not limited thereto. The structure of the communication device may not be limited by FIG. 13. The communication device may be an independent device or may be part of a larger device. For example, the described communication device may be:
(1) an independent integrated circuit (IC), a chip, or a chip system or subsystem;
(2) a set with one or more ICs, optionally, the IC set may also include a storage component used for storing data and computer programs;
(3) an ASIC, such as a modem;
(4) a module that is capable of being embedded in other devices;
(5) a receiving device, a terminal device, an intelligent terminal device, a cellular phone, a wireless device, a handheld device, a mobile unit, an in-vehicle device, a network device, a cloud device, or an artificial intelligence device, etc.;
(6) others and so on.

For the case where the communication device may be a chip or a chip system, please refer to the schematic diagram of the structure of the chip shown in FIG. 14. The chip shown in FIG. 14 includes a processor 1401 and an interface 1402. The number of processors 1401 may be one or more, and the number of interfaces 1402 may be more than one.

For the case where the chip is configured to implement the function of the UE in the embodiment of the present disclosure, the processor 1401 is configured to perform steps S602 in FIG. 6, S702-S703 in FIG. 7, S802 in FIGS. 8, S902 and S904 in FIG. 9; and the interface 1402 is configured to perform steps S601 in FIG. 6, S701 in FIGS. 7, S801 and S803 in FIGS. 8, and S901 and S903 in FIG. 9.

For the case where the chip is configured to implement the function of the network device in the embodiment of the present disclosure, the processor 1401 is configured to perform steps S201 in FIG. 2, S301 in FIG. 3, S401 in FIGS. 4, and S501 in FIG. 5; and the interface 1402 is configured to perform steps S302 in FIG. 3, S402 in FIGS. 4, and S502-S503 in FIG. 5.

Optionally, the chip further includes a memory 1403, and the memory 1403 is configured to store necessary computer programs and data.

Those skilled in the art may also understand that various illustrative logical blocks and steps listed in the embodiments of the present disclosure may be implemented through electronic hardware, computer software, or a combination of the two. Whether such functions are implemented through hardware or software depends on the specific application and design requirements of the overall system. Those skilled in the art can use various methods to implement the described function for each specific application, but this implementation should not be understood as exceeding the scope of protection of the embodiments of the present disclosure.

An embodiment of the present disclosure also provides a determining system for implementing cell configuration. The system includes the communication device as a UE in the embodiment of FIG. 12, and the communication device as a network device in the embodiment of FIGS. 10-11: alternatively, the system includes the communication device as a UE in the embodiment of FIG. 13, and the communication device as a network device in the embodiment of FIG. 13.

The present disclosure also provides a readable storage medium that stores an instruction. The instruction, when executed by a computer, implements the functions of any of the foregoing method embodiments.

The present disclosure also provides a computer program product. The computer program product, when executed by a computer, implements the functions of any of the foregoing method embodiments.

The above embodiments may be implemented in whole or in part by software, hardware, firmware, or any combination thereof. When implemented by using software, the above embodiments may be implemented in whole or in part in the form of a computer program product. The computer program product includes one or more computer programs. When the computer program is loaded and executed on a computer, processes or functions are produced in whole or in part in accordance with the embodiments of the present disclosure. The computer may be a general purpose computer, a specialized computer, a computer network, or other programmable devices. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., infrared, wireless, microwave, etc.) manner to another website site, computer, server, or data center. The computer-readable storage medium may be any usable medium to which a computer has access, or a data storage device such as a server, data center, etc. containing one or more usable media integrated. The usable medium may be a magnetic medium (e.g., floppy disk, hard disk, tape), an optical medium (e.g., high-density digital video disc (DVD)), or a semiconductor medium (e.g., solid state disk (SSD)), etc.

Those ordinary skilled in the art can understand that the “first”, “second”, and other numerical numbers involved in the present disclosure are only differentiations for the convenience of description, and are not used to limit the scope of the embodiments of the present disclosure or indicate the sequential order.

The “at least one” in the present disclosure may also be described as one or more, and the “plurality” may be two, three, four, or more, without limitation in the present disclosure. In the embodiments of the present disclosure, for a kind of technical feature, the technical features in the kind of technical feature are distinguished by “first”, “second”, “third”, “A”, “B”, “C”, and “D”, etc. The technical features described by “first”, “second”, “third”, “A”, “B”, “C”, and “D”, etc. are in no order of sequence or size.

As used herein, the terms “machine-readable medium” and “computer-readable medium” refer to any computer program product, device, and/or apparatus (e.g., disc, optical disc, memory, programmable logic device (PLD)) configured to provide machine instructions and/or data to a programmable processor, including a machine-readable medium that receives machine instructions as machine-readable signals. The term “machine-readable signal” refers to any signal used for providing machine instructions and/or data to the programmable processor.

The systems and techniques described herein may be implemented in a computing system that includes back-end components (e.g., as a data server), or a computing system that includes middleware components (e.g., an application server), or a computing system that includes front-end components (e.g., a user computer that has a graphical user interface or a web browser through which a user can communicate with the implementation of the system and technique described herein), or a computing system that includes any combination of such back-end components, middleware components, or front-end components. The components of the system may be interconnected via digital data communications (e.g., communication networks) in any form or medium. Examples of the communication networks include local area networks (LANs), wide area networks (WANs), and the Internet.

A computer system may include a client and a server. The client and the server are generally remote from each other and typically interact via a communication network. The client-server relationship is created by computer programs that run on corresponding computers and have a client-server relationship with each other.

The present disclosure proposes a method and apparatus for determining cell configuration, which can provide energy saving mode configuration for a cell, thereby achieving the purpose of reducing an energy consumption of a base station.

An embodiment of the present disclosure provides a method for determining cell configuration. The method is performed by a base station, and includes determining energy saving mode configuration for a cell located within a coverage of the base station. Herein, an energy consumption of the base station caused by the cell using the energy saving mode configuration is lower than an energy consumption of the base station caused by the cell not using the energy saving mode configuration.

In an example, the method further includes sending to another base station energy saving mode information indicating the energy saving mode configuration.

In an example, the method further includes sending, to a user equipment (UE) served by the cell or by a neighbor cell of the cell, energy saving mode information indicating the energy saving mode configuration.

In an example, the sending, to the UE served by the cell or by the neighbor cell of the cell, the energy saving mode information indicating the energy saving mode configuration includes sending the energy saving mode information to the UE through a system broadcast or a radio resource control (RRC) signaling.

In an example, the method further includes sending, to the UE served by the cell or by the neighbor cell of the cell, energy saving mode activation information indicating activation of the energy saving mode configuration.

In an example, the sending, to the UE served by the cell or by the neighbor cell of the cell, the energy saving mode activation information indicating the activation of the energy saving mode configuration includes sending the energy saving mode activation information to the UE through downlink control information (DCI).

In an example, the energy saving mode configuration includes configuring any one of: a sending period of a synchronization signal and a physical broadcast channel (PBCH) block, a number of an available beam, or a silence pattern.

An embodiment of the present disclosure provides a method for determining cell configuration. The method is performed by a UE, and includes receiving energy saving mode information sent by a base station. Herein, the energy saving mode information is used for indicating energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration. The method further includes determining, based on the energy saving mode information, the energy saving mode configuration of the current serving cell and the neighbor cell of the current serving cell.

In an example, the method further includes determining a new serving cell based on the energy saving mode configuration of the current serving cell and the neighbor cell of the current serving cell.

In an example, the receiving the energy saving mode information sent by the base station includes receiving, through a system broadcast or an RRC signaling, the energy saving mode information sent by the base station.

In an example, the method further includes receiving energy saving mode activation information sent by the base station for indicating activation of the energy saving mode configuration.

In an example, the receiving the energy saving mode activation information sent by the base station for indicating the activation of the energy saving mode configuration includes receiving, through downlink control information, the energy saving mode activation information sent by the base station.

In an example, the energy saving mode configuration includes configuring any one of: a sending period of a synchronization signal and a PBCH block, a number of an available beam, or a silence pattern.

An embodiment of the present disclosure provides an apparatus for determining cell configuration. The apparatus includes a processing module that is configured to determine energy saving mode configuration for a cell located within a coverage of a base station. Herein, an energy consumption of the base station caused by the cell using the energy saving mode configuration is lower than an energy consumption of the base station caused by the cell not using the energy saving mode configuration.

An embodiment of the present disclosure provides an apparatus for determining cell configuration. The apparatus includes a transceiver module that is configured to receive energy saving mode information sent by a base station. Herein, the energy saving mode information is used for indicating energy saving mode configuration of a current serving cell of a UE and a neighbor cell of the current serving cell, and an energy consumption of the base station caused by a cell using the energy saving mode configuration is lower than an energy consumption of the base station caused by the cell not using the energy saving mode configuration. The apparatus further includes a processing module that is configured to determine, based on the energy saving mode information, the energy saving mode configuration of the current serving cell and the neighbor cell of the current serving cell.

The embodiments of the present disclosure provide the method and apparatus for determining the cell configuration, where the base station determines the energy saving mode configuration for the cell located within the coverage of the base station, and the energy consumption of the base station caused by the cell using the energy saving mode configuration is lower than the energy consumption of the base station caused by the cell not using the energy saving mode configuration. As a result, the energy saving mode configuration is provided for the cell, and the purpose of reducing the energy consumption of the base station can be achieved by using the energy saving mode configuration.

In addition, the base station sends to the UE the energy saving mode information indicative of the energy saving mode configuration of the serving cell of the UE and the neighbor cell of the serving cell, and the UE determines, based on the energy saving mode information, the energy saving mode configuration of the serving cell and the neighbor cell of the serving cell. As a result, the UE is capable of obtaining, based on the energy saving mode configuration of the serving cell and the neighbor cell of the serving cell, capabilities of the serving cell and the neighbor cell of the serving cell to provide services for the UE.

It should be understood that steps may be reordered, added, or deleted by using various forms of processes shown above. For example, the steps documented in the present disclosure may be performed in parallel or sequentially or in a different order, as long as they can achieve the results desired by the technical solutions disclosed in the present disclosure, which are not limited herein.

Furthermore, it should be understood that the various embodiments described in the present disclosure may be implemented individually or in combination with other embodiments as permitted by the scheme.

Those ordinary skilled in the art can realize that the units and algorithm steps of each example described in combination with the disclosed embodiments in this article may be implemented in electronic hardware, or a combination of computer software and electronic hardware. Whether these functions are executed in hardware or software depends on the specific application and design constraints of the technical solution. Professional technicians may use different methods to implement the described functions for each specific application, but such implementation should not be considered beyond the scope of the present disclosure.

Those skilled in the art can clearly understand that for the convenience and conciseness of the description, the specific working processes of the systems, apparatus, and units described above may refer to the corresponding processes in the aforementioned method embodiments, and will not be repeated here.

The above is only the detailed description of the present disclosure, but the scope of protection of the present disclosure is not limited to this. Any technician familiar with this technical field can easily think of changes or replacements within the technical scope disclosed in the present disclosure, and these changes or replacements should be covered within the scope of protection of the present disclosure. Therefore, the scope of protection of the present disclosure shall be subject to the scope of protection of the claims.

1. A method for determining cell configuration, wherein the method is performed by a base station, and comprises:
determining energy saving mode configuration for a cell located within a coverage of the base station, wherein an energy consumption of the base station caused by the cell using the energy saving mode configuration is lower than an energy consumption of the base station caused by the cell not using the energy saving mode configuration.

2. The method according to claim 1, further comprising:
sending to another base station energy saving mode information indicating the energy saving mode configuration.

3. The method according to claim 1, further comprising:
sending, to a user equipment (UE) served by the cell or by a neighbor cell of the cell, energy saving mode information indicating the energy saving mode configuration.

4. The method according to claim 3, wherein the sending to the UE the energy saving mode information comprises:
sending the energy saving mode information to the UE through a system broadcast or a radio resource control (RRC) signaling.

5. The method according to claim 3, further comprising:
sending, to the UE, energy saving mode activation information indicating activation of the energy saving mode configuration.

6. The method according to claim 5, wherein the sending to the UE the energy saving mode activation information comprises:
sending the energy saving mode activation information to the UE through downlink control information (DCI).

7. The method according to claim 1, wherein the energy saving mode configuration comprises configuration for any one of:
a sending period of a synchronization signal and a physical broadcast channel (PBCH) block;
a number of an available beam; or
a silence pattern.

8. A method for determining cell configuration, wherein the method is performed by a user equipment (UE), and comprises:
receiving energy saving mode information sent by a base station, wherein the energy saving mode information indicates energy saving mode configuration of a current serving cell of the UE and a neighbor cell of the current serving cell, and an energy consumption of the base station caused by a cell using the energy saving mode configuration is lower than an energy consumption of the base station caused by the cell not using the energy saving mode configuration; and
determining, based on the energy saving mode information, the energy saving mode configuration of the current serving cell and the neighbor cell.

9. The method according to claim 8, wherein the receiving the energy saving mode information sent by the base station comprises:
receiving, through a system broadcast or a radio resource control (RRC) signaling, the energy saving mode information sent by the base station.

10. The method according to claim 8, further comprising:
determining a new serving cell based on the energy saving mode configuration of the current serving cell and the neighbor cell.

11. The method according to claim 8, further comprising:
receiving energy saving mode activation information sent by the base station for indicating activation of the energy saving mode configuration.

12. The method according to claim 11, wherein the receiving the energy saving mode activation information sent by the base station comprises:
receiving, through downlink control information (DCI), the energy saving mode activation information sent by the base station.

13. The method according to claim 8, wherein the energy saving mode configuration comprises configuration for any one of:
a sending period of a synchronization signal and a physical broadcast channel (PBCH) block;
a number of an available beam; or
a silence pattern.

14. (canceled)

15. (canceled)

16. A communication device, comprising:
a transceiver;
a memory; and
a processor, connected to the transceiver and the memory respectively,
wherein the processor is configured to:
determine energy saving mode configuration for a cell located within a coverage of a base station, wherein an energy consumption of the base station caused by the cell using the energy saving mode configuration is lower than an energy consumption of the base station caused by the cell not using the energy saving mode configuration.

17. A communication device, comprising:
a transceiver;
a memory; and
a processor, connected to the transceiver and the memory respectively,
wherein the processor is configured to perform the method according to claim 8.

18. A non-transitory computer-readable storage medium storing a computer-executable instruction that, when executed by a processor, causes the processor to perform the method according to claim 1.

19. A non-transitory computer-readable storage medium storing a computer-executable instruction that, when executed by a processor, causes the processor to perform the method according to claim 8.

20. The communication device according to claim 16, wherein the processor is further configured to:
send to another base station energy saving mode information indicating the energy saving mode configuration.

21. The communication device according to claim 16, wherein the processor is further configured to:
send, to a user equipment (UE) served by the cell or by a neighbor cell of the cell, energy saving mode information indicating the energy saving mode configuration.

22. The communication device according to claim 21, wherein the processor is specifically configured to:
send the energy saving mode information to the UE through a system broadcast or a radio resource control (RRC) signaling.
